(19) United States
(12) Patent Application Publication
(10) Pub. No.: US 2017/0116653 A1
(43) Pub. Date: Apr. 27, 2017

(54) SYSTEMS AND METHODS FOR ANALYTICS BASED PRICING OPTIMIZATION WITH COMPETITIVE INFLUENCE EFFECTS

(71) Applicant: REVIONICS INC., Austin, TX (US)

(72) Inventors: Anthony Smith, Austin, TX (US); Keith Vertrees, Austin, TX (US); Geoffrey Pofahl, Austin, TX (US); Jeffrey Moore, Austin, TX (US); Cem Vardar, Austin, TX (US); Robert Wood, Austin, TX (US); Shareth Hariharan, Austin, TX (US); Randolph Reiss, Austin, TX (US)

(73) Assignee: REVIONICS INC., Austin, TX (US)

(21) Appl. No.: 15/331,542

(22) Filed: Oct. 21, 2016

Related U.S. Application Data
(60) Provisional application No. 62/244,617, filed on Oct. 21, 2015.

(51) Int. Cl. G06Q 30/02; G06F 17/11; G06F 17/18; G06Q 10/06

(52) U.S. Cl. CPC G06Q 30/0283; G06Q 10/067; G06Q 30/0206; G06F 17/11; G06F 17/18

(57) ABSTRACT

The embodiments described herein can provide systems and methods utilize competitive history data to provide improved pricing recommendations for sellers. This competitive history data can include a time series of one or more competitor's prices for a set of products. This use of competitive history data to provide improved pricing recommendations to sellers introduces significant non-convexity to the determination of pricing recommendations. Accordingly, the systems and methods described herein employ a variety of technical approaches to generating the price recommendations in light of this introduced complexity. Additionally, the systems and methods employ various techniques to providing these price recommendations even when competitive history data is limited. Specifically, by using the limited to competitive history data to generate constraints, where the constraints can then be used for additional price optimizations where competitive history data is unavailable.

### PRIORITY CLAIM

This application claims priority to U.S. Provisional Patent Application Ser. No. 62/244,617, filed Oct. 21, 2015, which is hereby incorporated by reference in its entirety.

### TECHNICAL FIELD

Embodiments disclosed herein relate generally to inventory systems, and more particularly, to product pricing in inventory systems.

### BACKGROUND

In modern retailing the pricing of products is often controlled by retailer pricing systems. These retailer pricing systems allow the seller to set the prices of products in a store and/or online, and are configured to ensure that customer is charged the appropriate price when checking out. One issue with such retailer pricing systems is the inability to set prices for products at appropriate levels to meet objectives. For example, in typical retailing systems there is no ability to automatically respond to price elasticity and other factors to determine optimal prices and meet various objectives.

As one specific example, in current retailer pricing systems there is no ability to account for the effects of competitor pricing in meeting objectives. For example, there is no ability to account for the effects of competitive price switching, where customers switch to or from a seller based on price differences with a competitor. Furthermore, there is no ability to use the price histories of competitors in determining optimal prices and the setting of those prices in the retailer pricing system. Without the use competitive price histories in the setting of prices, the ability set prices to optimal levels to meet objectives is significantly limited. To overcome this, some retailers attempt to use blanket price matching strategies. Unfortunately, the use of blanket price matching strategies is also less than ideal, as using such blanket price matching strategies cannot provide the ability to use optimal prices in a way that meets defined objectives. Thus, there thus remains a continuing need for improvements in retailing pricing systems, specifically, a need to provide the ability to account for competitive price histories in the setting of prices.

### BRIEF SUMMARY

This summary is provided to introduce a selection of concepts in a simplified form that are further described below in the detailed description. This summary is not intended to identify key features or essential features of the claimed subject matter, nor is it intended to be used as an aid in determining the scope of the claimed subject matter.

In general, the embodiments described herein provide systems and methods for optimizing prizes. Specifically, these systems and methods utilize competitive history data to provide improved pricing recommendations for sellers. This competitive history data can include a time series of one or more competitor's prices for a set of products. The systems and methods described herein can use this competitor price data with a corresponding time series of seller's data on their product prices and resulting demand to provide improved pricing recommendations to the seller.

In particular, the systems and methods use the competitive history data to generate constraints that are used in to determine improved pricing recommendations. This use of competitive history data to provide improved pricing recommendations to sellers introduces significant complexity to the optimization of prices. Specifically, this use of competitive history data introduces significant non-convexity to the determination of pricing recommendations. Accordingly, the systems and methods described herein employ a variety of technical approaches to generating the price recommendations in light of this introduced complexity. Additionally, the systems and methods employ various techniques to providing these price recommendations even when competitive history data is limited. Specifically, by using the limited to competitive history data to generate constraints, where the constraints can then be used for additional price optimizations where competitive history data is unavailable.

In a first embodiment, a method of price optimization is provided. This method comprises: performing a first modeling of demand for a set of products based at least in part on competitive history data for the set of products product, where the competitive history data includes a time series of competitors price for the set of products for at least a first competitor; generating optimization constraints based the first modeling of demand; performing a second modeling of demand of the set of products based at least in part on product data for the set of products; and generating optimized prices for the set of products based on the second modeling of demand and using the optimization constraints from the first modeling of demand.

In a second embodiment, a method of price optimization is provided. This method comprises: providing a plurality of demand models, with each demand model corresponding to a product in a set of products, and each demand model including a term representing an effect of competitive price history on product demand for the corresponding product in the set of products; generating coefficients for each of the plurality of demand models using Bayesian priors and empirical Bayesian estimation with shrinkage techniques using seller data and competitive history data, where the seller data includes a time series of quantity sold versus price for each product in the set of products for a first seller, and where the competitive history data includes a time series of competitors price for each product in the set of products for at least one competitor; providing an objective function, the objective function defining a business objective in terms of profit and revenue relating to the set of products, the objective function incorporating the plurality of demand models and generated coefficients for the plurality of demand models, and wherein the objective function includes significant non-convexity as a result of the demand model terms representing the effects of competitive price history on product demand; optimizing the objective function to find a Lagrange multiplier value that satisfy a business objective using a consensus forecast function produced with a Monte Carlo method; generating optimization constraints based the optimized objective function; performing a second modeling of demand of the set of products based at least in part on product data for the set of products; and generating optimized prices for the set of products that meet a business objective based on the second modeling of demand and using the optimization constraints from the first modeling of demand.

### BRIEF DESCRIPTION OF THE DRAWINGS

A more complete understanding of the subject matter may be derived by referring to the detailed description and claims when considered in conjunction with the following figures, wherein like reference numbers refer to similar elements throughout the figures.

FIG. 1 is a schematic diagram of a pricing optimization system in accordance with an exemplary embodiment;

FIG. 2 is a graphical representation of demand curves in accordance with an exemplary embodiment;

FIG. 3 is a graphical representation of efficient frontier curves in accordance with an exemplary embodiment;

FIG. 4 is a flow diagram of a method 400 in accordance with an exemplary embodiment;

FIG. 5 is a flow diagram of a method 500 in accordance with an exemplary embodiment;

FIG. 6 is a flow diagram of a method 600 in accordance with an exemplary embodiment;

FIG. 7 is a flow diagram of a method 700 in accordance with an exemplary embodiment;

FIG. 8 is a graphical representation of exemplary results from applying random perturbations to an objective function in accordance with an exemplary embodiment;

FIG. 9 is a graphical representation of exemplary optimized objective functions for different values of the Lagrange multiplier in accordance with an exemplary embodiment;

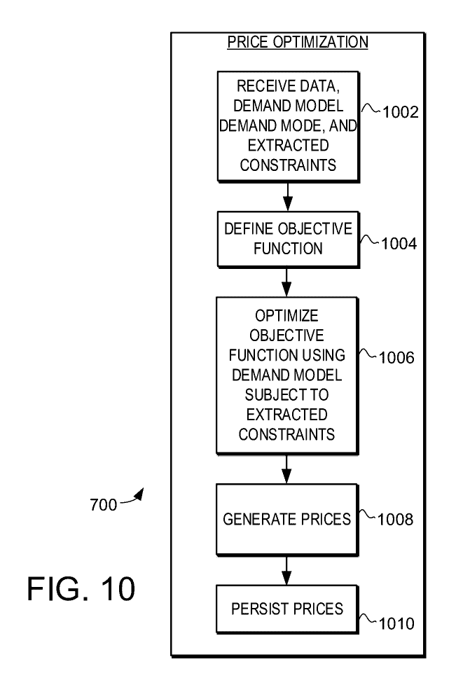

FIG. 8 is a flow diagram of a method 800 in accordance with an exemplary embodiment;

FIG. 10 is a flow diagram of a method 900 in accordance with an exemplary embodiment;

FIG. 11 is a schematic diagram of a computing system in accordance with an exemplary embodiment.

### DETAILED DESCRIPTION

In general, the embodiments described herein provide systems and methods for optimizing prizes. Specifically, these systems and methods utilize competitive history data, along with other data, and a variety of statistical techniques, to generate specific pricing recommendations for a set of products. In general, this competitive history data includes the pricing history of competitors to a seller over a set time period. More specifically, this competitive history data can include a time series of prices for each product in the set of prices for one or more different competitors. The systems and methods described herein can use such a time series of competitive history data, along with a corresponding time series of seller's data on their product prices and resulting demand, to generate pricing recommendations for each product in the set of products in a way that meets defined objectives. In particular, the systems and methods use the competitive history data to generate constraints that are used to determine improved pricing recommendations. These pricing recommendations can then be applied to a retailer pricing system to automatically set the prices at those recommended levels.

This use of competitive history data introduces significant complexity to the determination of pricing recommendations. Specifically, the use of time series of competitor pricing information into the modeling of demand introduces significant non-convexity to the determination of pricing recommendations. Accordingly, the systems and methods described herein employ a variety of technical approaches to generating the price recommendations in light of this significant introduced non-convexity. As will be described in greater detail below, these technical approaches can include specialized techniques for modeling demand while accounting for competitive influence, generating coefficients for such demand modeling, optimization of objective functions using such demand models and coefficients, and the use of such optimization to determine constraints that are used for pricing recommendations.

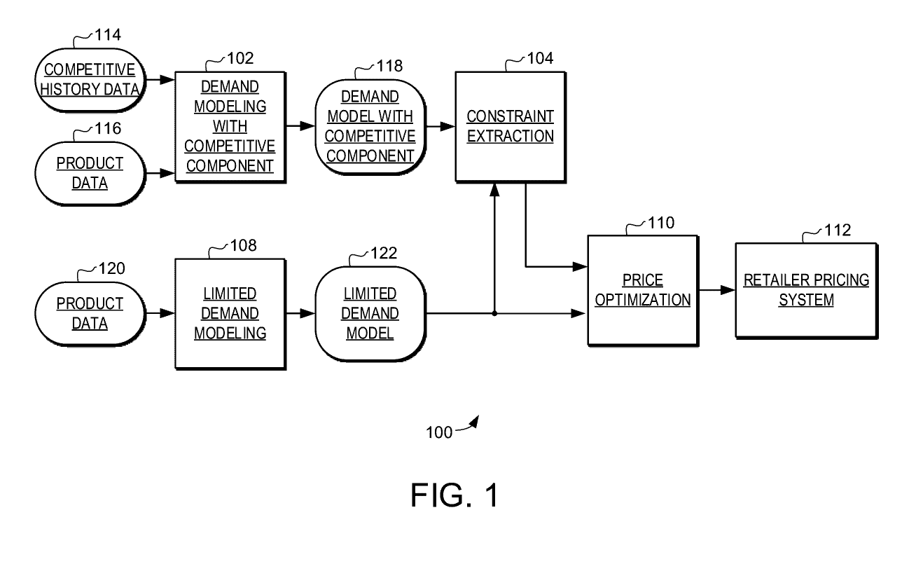

Turning now to FIG. 1, an exemplary pricing optimization system 100 is illustrated. The pricing optimization system 100 includes a demand modeling module 102, a constraint extraction module 104, a limited demand modeling module 108, a price optimization module 110, and a retailer pricing system 112. In general, the demand modeling module 102 receives competitive history data 114 and product data 116, and generates a demand model 118 with competitive components. The demand model 118 is then used by the constraint extraction module 104 to generate optimization constraints.

The limited demand modeling module 108 receives product data 120, and generates a limited demand model 122. The price optimization module 110 receives the optimization constraints and limited demand model 122 and generates price recommendations. The price recommendations are then provided to the retailer pricing system 106.

It should be noted that the limited demand model 122 does not receive, and thus does not use competitive history data 114. Stated another way, the limited demand model 122 does not include a competitive component, and does not include terms representing the effects of competitor's pricing on product demand. This allows the limited demand modeling module 108 to be utilized even in the situations where comprehensive competitive history data is unavailable. However, the pricing optimization system 100 can still account for the effects of competitor's pricing on demand by using the constraints generated by constraint extraction module 104.

Specifically, the competitive history data 114, demand model 118 and constraint extraction module 104 can be used to generate constraints during a first modeling of demand, with those constraints configured to approximate the effects of competitor pricing when generating pricing recommendations. Furthermore, these constraints can be generated with limited amounts of data on competitor's pricing history. For example, in some embodiments the constraints may be generated using only older competitive history data. With those constraints generated they can be used to by the price optimization module 110 to facilitate price optimization for situations where competitive history data is unavailable during a second modeling of demand. For example, by using those constraints to generate pricing recommendations for current product pricing when no current competitive pricing data is available. Thus, the embodiments described herein can provide optimized prices even when the competitive history data is limited such that direct optimization using that data would not be possible. This approach also allows for generalization of competitive pricing policies from items where competitive effects are robustly observed and modeled to a broader set of items for which limited or infrequently-collected competitor price history renders estimates of competitor switching effects unreliable.

As will be described below, because the demand modeling module 102 incorporates competitive components into the demand model 118, the demand model 118 will result in significant non-convexity in an objective function, such as multiple extrema in the objective function. Accordingly, the constraint extraction module 104 is configured to use techniques designed to optimize such a non-convex objective function to generate optimization constraints, and the price optimization module 110 is configured to use these optimization constraints to determine pricing recommendations.

The product data 116 can include a variety of data regarding the products. For example, the product data 116 can include information regarding the seller's history with the products, where the seller is the entity for which prices are being optimized by the system 100. Specifically, the product data can include a time series of quantity sold versus price for the set of products for the seller. This information provides a demand history of the product, and that demand history can show how demand for a product changes in response to variables such as price, season and promotions. In general, it can be desirable to provide a high frequency time series of seller's data, for a relatively large duration, and for multiple products. The product data 116 can also include other types of data. For example, the product data can include data on product cost, data on product categories and hierarchies.

As was stated above, the competitive history data 114 will include information on the pricing history of one or more competitors. For example, competitive history data 114 can include a time series of data indicating the pricing of a product or set of products by one or more competitors. In general, it is again desirable to provide a high frequency time series of data, for a relatively large duration, and for multiple products. For example, the time series of competitive pricing data can include weekly prices for a set of prices spanning a one or two year time duration. Such a comprehensive time series of data can be used to provide effective price optimization that accounts for the effects of competitive switching to and from the competitor. Of course, in some situations such high frequency or long duration competitive history data may not be available. In those cases, more limited (e.g., shorter duration, less frequent) time series of data can be used, but with some resulting negative impact on the ability to fully optimize prices based on that more limited data.

As illustrated in FIG. 1, the demand modeling module 102 receives competitive history data 114 and product data 116, and generates a demand model 118 with competitive components. In general, the demand modeling module 102 can be configured to provide one or more demand models 118, with each demand model 118 corresponding to a product in a set of products, and each demand model 118 including at least one term representing an effect of competitive price history on product demand for the corresponding product in the set of products. The demand modeling module 102 will be further configured to generate coefficients for each of the plurality of demand models 118 using the competitive history data. In one particular embodiment, the demand modeling module 102 will generate these coefficients by performing an empirical Bayesian estimation using the competitive history data 114.

As illustrated in FIG. 1, the demand models 118 for each product generated by the demand modeling module 102 are provided to the constraint extraction module 104. In general, the constraint extraction module 104 uses the demand models 118 to determine constraints that will be used to generate price recommendations by the price optimization module 110. In one embodiment, the constraint extraction module 104 uses an objective function to generate constraints from the demand models 118, where the objective function defines a business objective in terms of profit and revenue relating to the set of products. In such an embodiment the objective function incorporates the demand models 118 and the generated coefficients.

Such an objective function will include significant non-convexity as a result of the demand model terms representing the effects of competitive price history on product demand. For example, in some embodiments the use of the competitive components will result in a non-convex objective function with at least two dimensions of uncertainty. Accordingly, the constraint extraction module 104 is configured to use techniques designed to optimize such a non-convex objective function and determine constraints based on that optimization.

The constraint extraction module 104 can be implemented to optimize the objective function by finding values that maximize the objective function while also satisfying business objectives. In one embodiment, such a constraint extraction module 104 can be implemented to optimize the objective function by generating a consensus forecast function for each product in the set of products and using that consensus forecast function to determine product prices. In general, a consensus forecast function reflects a consensus among a plurality of differing forecasts, achieved by means of statistical aggregations, e.g. simple average, weighted average, median, or mode, as dictated by the application. In this embodiment, the consensus forecast function can be produced using a Monte Carlo method. In general, Monte Carlo methods are a broad class of techniques that apply repeated random perturbations at the input, measure the results, and use the relationship between the random inputs and corresponding results to generate consensus forecasts. In this embodiment, the Monte Carlo techniques are used to generate a consensus forecast function.

Specifically, in one embodiment, the constraint extraction module 104 can be implemented to select a set of Lagrange multipliers, and for each selected Lagrange multiplier, find a product price using the consensus forecast function that maximizes the objective function, and then determine which of the selected Lagrange multipliers and corresponding product prices satisfies the business objective.

With the Lagrange multiplier identified, an improved price for each of the set of the products can be identified by determining a local optimum in the derivative of the optimized objective function with respect to price for each of the set of products. Such improved prices can then be used to generate constraints.

Specifically, the constraints can be generated by performing an iterative simulation using the improved prices and the limited demand model 122 to determine what type of constraints, when applied to an optimization using the limited demand model 122, will result in an optimization that approximates the corresponding optimization using the full demand model 118. Stated another way, the improved prices generated using the full demand model 118 serve as a target for the iterative simulation using the limited demand model 122 such that the generated constraints will result in an optimization that approximates price optimization using the competitive components when applied to optimization using the limited demand model 122. Those constraints are passed to the price optimization module 110, where they are used with the limited demand model 122 to generate optimized prices. For example, these constraints in particular take the form of competitive pricing policies that influence optimized prices to take on values within a specified tolerance of a relative price index of a competitor's price for one or more items.

The final optimized prices can then be provided to the retailer pricing system 112, where the retailer pricing system 106 can utilize the optimized prices to set prices for the retail store. As one example, the retailer pricing system 106 can update prices in an online catalog or shopping system. In another example, the retailer pricing system 106 can update prices for physical point of sale checkout systems. In some cases the retailer pricing system can additionally be used to generate physical pricing indicators for placement on products or store shelves.

As was noted above, the use of competitive history data introduces significant complexity. Specifically, the use of time series of competitor pricing information into the modeling of demand introduces significant non-convexity to the modeling of demand the optimization of objective functions. Thus, demand modeling module 102 and constraint extraction module 104 are configured to employ a variety of technical approaches to generating the constraints are applied to the price optimization module 110.

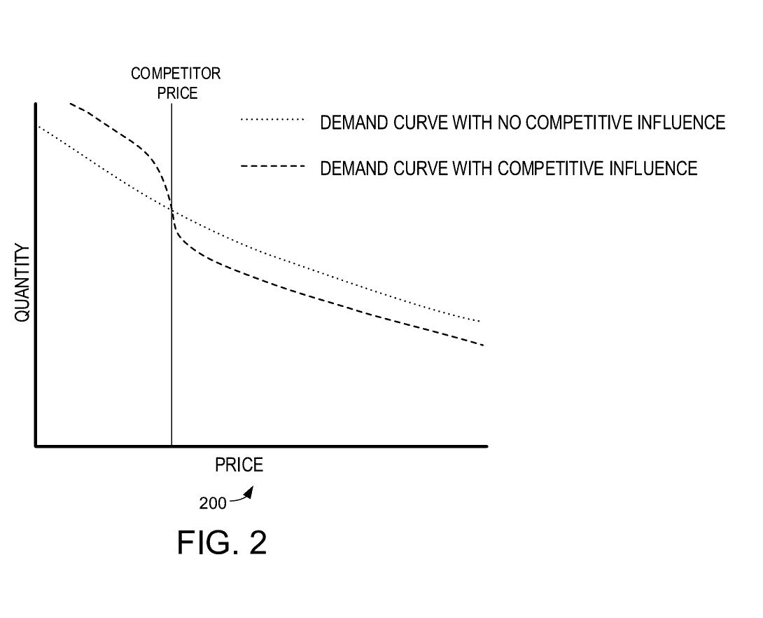

Turning now to FIG. 2 a graph 200 illustrates exemplary demand curves for an exemplary product. Specifically, graph 200 includes a first exemplary demand curve for a product that is derived from a demand model that does not include the effects of competitive influence, and a second exemplary demand curve for the product that is derived from a demand model that does include the effects of competitive influence. As can be seen in graph 200, the demand curve with no competitive influence is a relatively smooth curve with consistent transition, with demand decreasing as prices increase. This represents basic price elasticity in a product. In contrast, the demand curve that accounts for the effect of the competitive influence has a noticeable region of higher slope, with that region of higher slope corresponding to “fast switching” behavior by customers at prices near the competitor's price. It is that region of higher slope in the demand curve and resulting fast switching that gives rise to significant non-convexity and two dimensional uncertainties in the demand model and corresponding objective function.

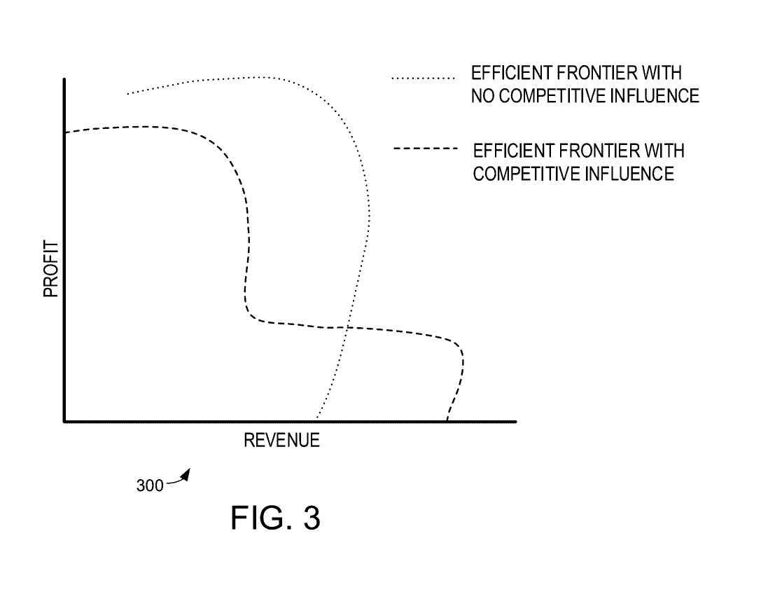

Turning now to FIG. 3 a graph 300 illustrates exemplary efficient frontiers. In general, these efficient frontiers represent price possibilities that can meet desired business objectives between profit and revenue. In graph 300 includes a first exemplary efficient frontier for a seller derived from a demand model that does not include the effects of competitive influence, and a second exemplary efficient frontier for a seller derived from a demand model that does include the effects of competitive influence. As can be seen in graph 300, the efficient frontier with no competitive influence is a relatively convex. In contrast, the efficient frontier that takes into account the effect of the competitive influence has a noticeable non-convexity that results from the competitive components. It is that non-convexity that can require specialized techniques for optimization of prices on that efficient frontier.

As described above, the competitive history data can include data regarding multiple competitors. For example, a typical brick and mortar retailer may have multiple competitors that sell the same type of goods and a relatively close geographically. Likewise, online retailers can have multiple competitors targeting the same customers with the same goods. To facilitate effective pricing, the competitive history data used to determine pricing recommendations can include a time series of data for each product for each of multiple different competitors. In determining recommended prices for a seller using such data on multiple competitors' pricing, it is generally desirable to more heavily weight the data from competitors that have the greatest influence on the seller's demand. For example, by more heavily weighting the competitive influence of competitors that cause the steepest slope in “fast switching” portion of the demand curve (e.g., the demand curve with competitive influence illustrated in FIG. 2).

A variety of techniques can be used to determine the relative competitive influence of multiple competitors and applying that relative influence to the optimization of prices. For example, in one embodiment the competitive relationship between a seller and each of multiple competitors can be tested simultaneously by modeling the sensitivity to each competitor and generating a sensitivity coefficient for each competitor from that modeling. These sensitivity coefficients can then be applied as demand model coefficients to weight the impact of the corresponding competitor on demand for the corresponding product. For example, the relative impact from three competitors three for a particular product could be weighted as 0.6, 0.3, and 0.1, where each weight is applied as sensitivity coefficients for each product sold by those competitors. Additionally, in some embodiment it may be desirable to further weight the sensitivity coefficients according to the confidence level in the competitive history data.

In one embodiment, this determination of sensitivity coefficients and the corresponding weighting can be performed as part of the demand modeling and generating of coefficients performed by the demand modeling module 102. In another embodiment, this determination can be performed prior to this modeling. For example, it can be used as part of a preliminary process to determine which competitors and for what products to include in the competitive history data 114 and for which products. And in some cases a combination of both embodiments can be used.

Finally, it should be noted that the determination of such sensitivity coefficients generally comprises determining a separate coefficient can for each competitor/product combination. Thus, the effect of each competitor can weighted separately for different products and thus more accurately reflect real life competitive impacts on demand.

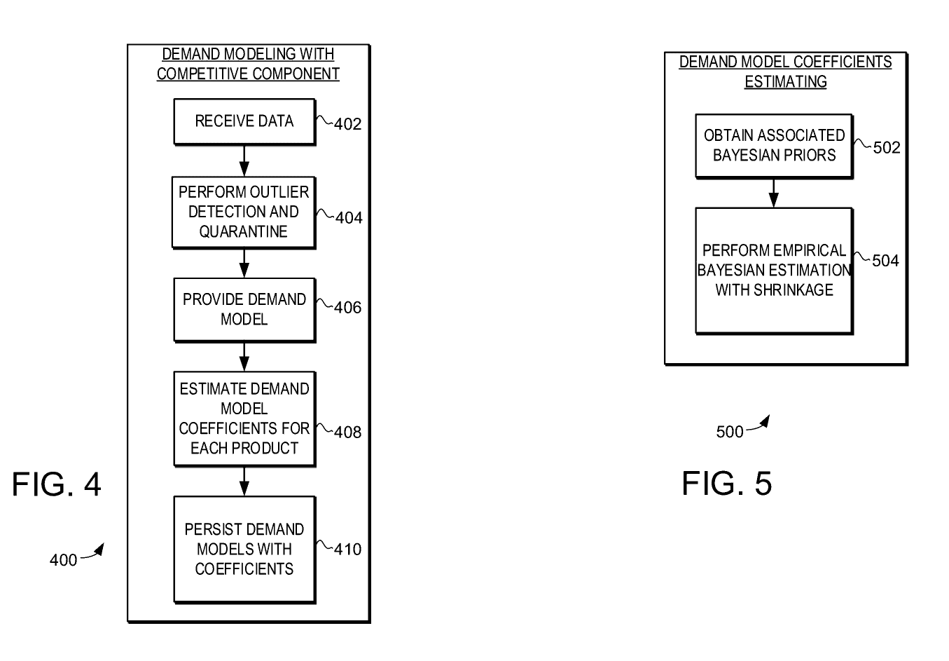

Turning now to FIG. 4, a demand modeling method 400 is illustrated. The demand modeling method 400 is an example of the type method that could be performed by a demand modeling module in situations with significant non-convexity (e.g., demand modeling module 102 of FIG. 1).

The first step 402 in method 400 is to receive data. As was described above, this data will include product data, such as product cost, product categories and hierarchies. Additionally, this product data will typically include information on the seller's demand history of the product, including the quantity sold versus price for the set of products for the seller. And in accordance with the embodiments described herein, the received data will also include competitive history data, such as one or more time series of data indicating the pricing of a set of products by one or more competitors.

The next step 404 is to perform outlier detection and quarantine. In general, outlier detection and quarantine is performed to remove data that is likely to be corrupted. This step thus helps ensure that only good data is used in the modeling of demand. This step can be accomplished by evaluating data to determine if the data is beyond the range of expected variation, and thus can be safely assumed to be corrupted. Data that is beyond the expected range can then be quarantined or otherwise not used in the demand modeling. It should be noted that in performing step 404 any suitable technique for outlier detection and quarantine can be used.

The next step 406 is to provide a demand model. In general, demand models are used to predict how much demand will exist for a product under a defined set of conditions. To provide this predictive ability, demand models provide an expression of quantity sold as a function of price and other variables. In accordance with the embodiments described herein, the demand models use competitive history data combined with other product data to more accurately predict demand. A general expression of an exemplary demand model that uses competitive history data to predict a quantity sold Q as function of time for one seller and n competitors can be represented as:

Q₍ₜ₎=ƒ(Price(t)ₛₑₗₗₑᵣ),(Price(t)_{comp}_{_}₁),(Price(t)_{comp}_{_}₂) . . . (Price(t)_{comp}_{_}ₙ) Equation 1.

Thus, the demand model represented in Equation 1 predicts the demand a seller will experience for a product as a function of that seller's price and the prices n competitors. Of course, this is just a simplified representation of such a demand model, and a typical demand model will include additional terms representing additional factors that also influence demand. For example, in addition to sellers and competitor's price, such a demand model can include terms relating to the product itself, time varying factors, and the possibilities of product substation.

Also included in such demand models are various variables, referred to herein as coefficients. As will be described with reference to the next step of method 400, these demand model coefficients are determined from the input data, and when determined provide a specific instantiation of the demand model for a corresponding product.

As one specific example, a demand model, where Qᵢ is the predicted number of items i that will be sold under the conditions described by the demand model, can be implemented as:

Qᵢ=D(t)·X(t)·uᵢ Equation 2

where D(t) represents the time varying demand signature, X(t) represents the time varying substitution pressure for competing products and is a function of computing utility of substitutable product options, and uᵢ represents the utility of the item. The utility of an item uᵢ includes intrinsic demand characteristics of the item as a function of price, promotion, availability and popularity relative to other substitutable items. In accordance with the embodiments described herein, uᵢ would be implemented with additional terms representing an effect of competitive price history on product demand. To accomplish this, uᵢ could be implemented to include a non-linear function describing the demand characteristics resulting from competitive influence. As one specific example, uᵢ could be implemented with a generalized linear model (GLM) as:

ƒ(Σᵢ₌₁^{N}αᵢβᵢ) Equation 3

where αᵢ represents a demand driver and βᵢ represents a sensitivity parameter. To provide a demand model that includes the effects of competitor price influence, the function ƒₒ can be implemented as a log linear, exponential function, with the sensitivity parameter βᵢ determined by a modeling engine, and the demand driver αᵢ representing effects of competitor price as:

$$f ( \frac{{P}_{c} - {P}_{seller}}{{P}_{seller}} ) \qquad Equation 4$$

where P_{c} is the competitor price, and Pₛₑₗₗₑᵣ is the sellers price, and the function ƒ( ) is a logistic function in the form of:

$$f ( x ) = ( \frac{1}{1 + {e}^{- x}} ) \qquad Equation 5$$

where x is defined as:

$$\frac{{P}_{c} - {P}_{seller}}{{P}_{seller}} . \qquad Equation 6$$

With such a demand model provided, the next step 208 is to estimate the coefficients of the demand model. As described above, each demand model includes multiple variables called coefficients. In this step, the received data is used to determine an estimation of those coefficients for each product. The estimation of these coefficients essentially generates a separate instantiation of the demand model for each product, and it is the separate instantiations of the demand model that will be used to determine an optimized price for each product.

Because of the inclusion of terms representing the effects of competitive price history on product demand and the resulting non-convexity, specialized techniques for estimating these coefficients are used in method 400. As one example, these coefficients can be estimated through the use of empirical Bayesian estimation. In general, empirical Bayesian estimation is a technique for statistical inference in which previous data is used to estimate a prior distribution. Then, from this estimate of the prior distribution, the coefficients of the demand model can themselves be estimated.

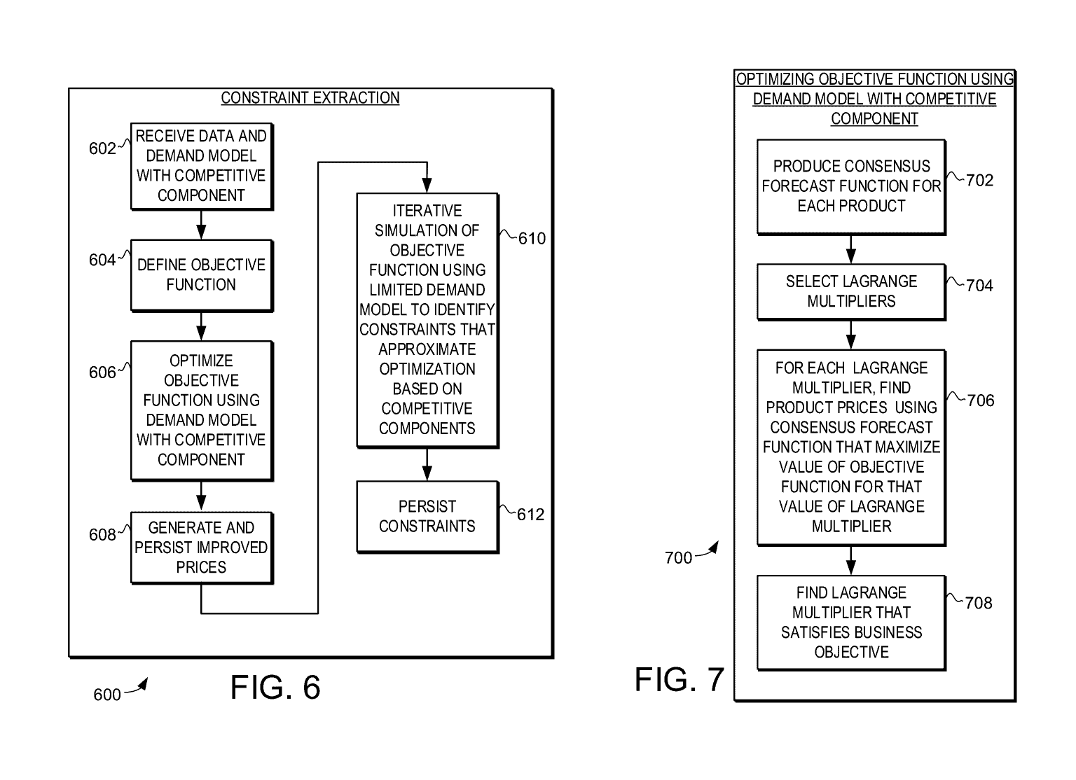

A detailed example of such an empirical Bayesian estimation technique will be discussed with reference to FIG. 5. It should be noted however, the other techniques for estimating the demand model coefficients can be used. Other examples of techniques that could be used include Maximum Likelihood, Least Squares estimation, regularized regression (Ridge or Lasso regression), or other estimation techniques.

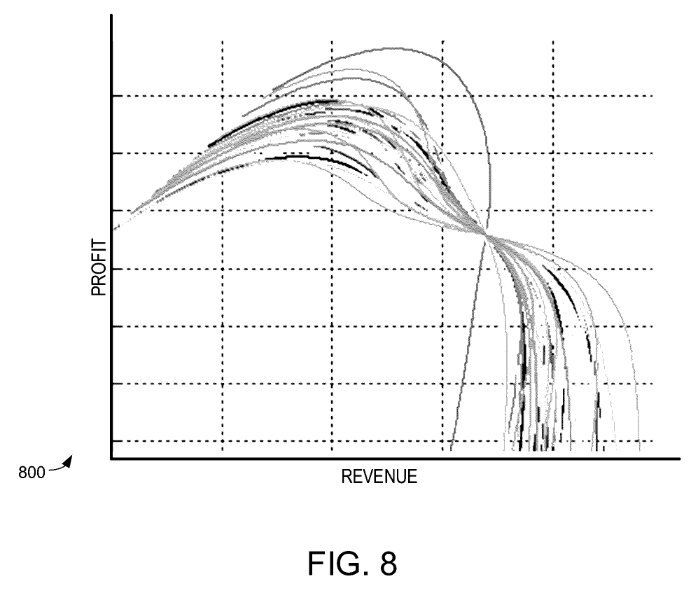

With the demand model coefficients determined, the next step 410 is to persist the coefficients. The demand model coefficients for each products are saved, and can then be used for price optimization (e.g., by price optimization module 110). A detailed example of how demand model coefficients can be used for price optimization will be described below with reference to FIG. 6 below.

Turning now to FIG. 5, a demand model coefficient estimating method 500 is illustrated. The coefficient estimating method 500 is an example of the type method that could be performed by a demand modeling module (e.g., demand modeling module 102 of FIG. 1). For example, it is a detailed example of the type of technique that could be used during step 408 of FIG. 4. In general, the method 500 estimates demand model coefficients by using an empirical Bayesian estimation with shrinkage technique.

The first step 502 in method 500 is to obtain associated Bayesian priors. In general, Bayesian priors are probability distributions, sometimes referred to as “prior probability distributions” or just “priors”. In step 502, these Bayesian priors provide an initial estimation of the distribution, and will be used in method 500 for estimating the demand model coefficients.

In one embodiment the Bayesian priors obtained in step 502 are empirically derived distributions, sometimes referred to as empirical priors. In such embodiments, the Bayesian priors would be obtained from previous determinations of the demand model coefficients. For example, the Bayesian priors can be determined by an initial estimation with general prior distributions which are subsequently replaced based on observed (i.e., empirical) distributions of measured parameters via the initial estimation step. Thus, the Bayesian priors provide empirical prior distributions by initial estimation without requiring a pre-formed understanding of statistical behavior within a population. Furthermore, subsequent estimation runs can use these empirically-derived distributions as Bayesian priors resulting in posterior estimates that are informed by measured ensemble behavior. Thus, the comparatively naïve initial distributions provided as input to the initial estimation step are replaced in subsequent steps by distributions formed from estimated values from the initial estimation of populace parameters. The modeler is free to choose the population over which distributions are derived, although this technique is most useful when similarity exists among the products in the population—consequently choice sets consisting of similar, substitutable products sharing similar products attributes and/or retailer hierarchy classification would be typical.

With the Bayesian priors determined, the next step 504 is to perform an empirical Bayesian estimation with shrinkage. In general, Bayesian estimation uses a likelihood maximization approach from a posterior distribution consisting of both a likelihood component relating to directly-observed data in conjunction with a prior distribution as described in previous steps. In step 504, that estimate of the distribution can be used to estimate the coefficients of each demand model.

Bayesian estimation with shrinkage is a type of Bayesian estimation that starts with the naïve or raw estimate provided by the Bayesian priors of step 502, and produces initial coefficient estimations. The results of these initial estimations are fed back into the input, and another Bayesian estimation is performed. This process of “shrinkage” is continued until the final estimation is determined. Thus, Bayesian estimation with shrinkage is a recursive process that incorporates both the priors and the resulting estimations, performing a shrinkage that continues until the final coefficient estimation is reached. In this case, such a shrinkage process could continue until all of the demand coefficients have been estimated to within a desired tolerance.

In one embodiment, the performing of Bayesian estimation with shrinkage is done with generalized linear model (GLM) solvers. In general, GLM solvers are specialized tools that can be used to perform estimation techniques. Such GLM solvers can be implanted with a variety of techniques and tools. For example, in step 504, the GLM solvers can be implemented with the “R” Statistical Programming language.

Again, it should be noted that Bayesian estimation with shrinkage is just one example of the type of techniques that can be used to estimate the coefficients of the demand models.

Turning now to FIG. 6, a constraint extraction method 600 is illustrated. The constraint extraction method 600 is an example of the type method that could be performed by a constraint extraction module (e.g., constraint extraction module 104 of FIG. 1).

The first step 602 in method 600 is to receive data and the demand model with estimated coefficients. This data will again include product data, such as product cost, product categories and hierarchies. Additionally, this product data will typically include information on the seller's demand history of the product, including the quantity sold versus price for the set of products for the seller. And in accordance with the embodiments described herein, the received data will also include competitive history data, such as one or more time series of data indicating the pricing of a set of products by one or more competitors. Additionally, the demand models with estimated coefficients are provided. The estimation of those demand model coefficients was described above with reference to FIGS. 4 and 5.

The next step 604 is to define an objective function. In general, the objective function defined in step 604 provides a representation of a business objective that is to maximized or otherwise optimized. For example, in a typical embodiment, the objective function is a combination of profit and revenue metrics. As one specific example, the objective function can be defined as:

Obj=P+λR Equation 7.

where P is profit, R is revenue, and λ is a Lagrange Multiplier that provides the combination of profit and revenue in the objective. It should be noted that with this objective function the choice of λ determines a choice of business strategy. In particular, lower values of cause a relatively high emphasis on profit, while higher values of cause a relatively high emphasis on revenue. Another representation of such an objective function can be expressed as:

Obj=Σ_{∇i}Pᵢ+λ[(Σ_{∇i}Rᵢ)] Equation 8.

where:

Pᵢ=Qᵢ^{(t)}(Priceᵢ−Costᵢ) Equation 9.

where:

Rᵢ=Qᵢ^{(t)})(Priceᵢ) Equation 10.

and where Qᵢ^{(t)} is the quantity of i items sold over time t, Priceᵢ is the price of item i, and Costᵢ is the cost of item i. Again, it should be noted that these are just examples of how an objective function can be implemented.

The next step 606 is to optimize the objective function using the demand model with competitive components. In general, optimization of the objective function finds the best possible outcome under for a given set of business constraints. Specifically, the optimization of the objective function uses the demand model and coefficients to determine the quantities of items that will be sold at given prices, and the optimization uses that to determine the prices that will result in the best outcome for a given business objective.

As was noted above, the objective function will include significant non-convexity as a result of the demand model terms representing the effects of competitive price history on product demand. For example, in some embodiments the use of the competitive components will result in a non-convex objective function with at least two dimensions of uncertainty. Accordingly, the constraint extraction performed in step 606 uses techniques designed to optimize such a non-convex objective function.

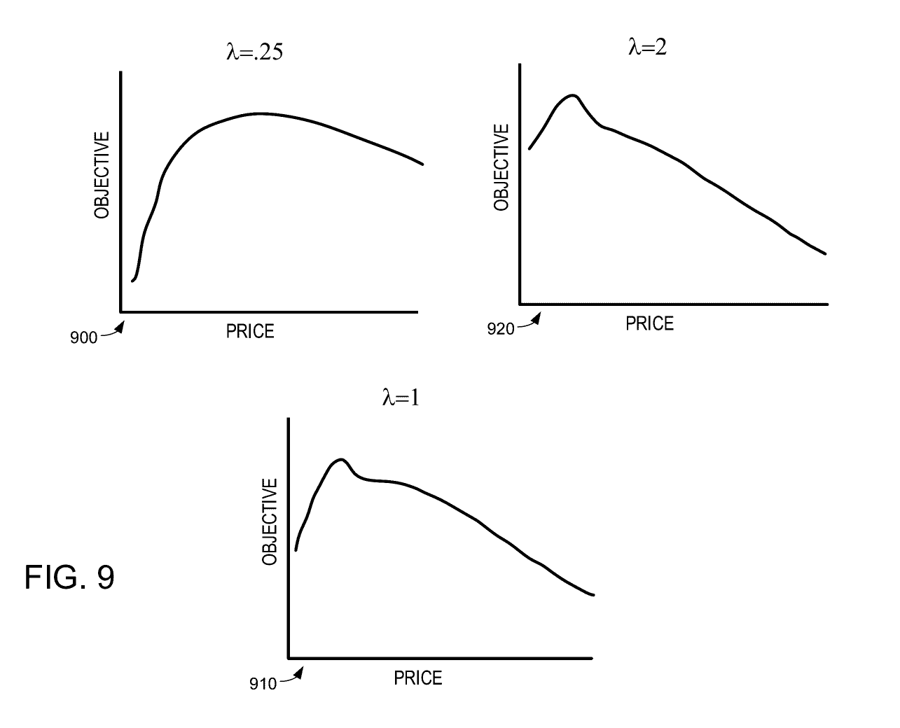

In one embodiment, the constraint extraction can be implemented to optimize the objective function by generating a consensus forecast function for the set of products and using that consensus forecast function to determine product prices. Specifically, in one embodiment, the constraint extraction can be implemented to select a set of values for the Lagrange multiplier in the objective function, and for each selected value of λ find a product price using the consensus forecast function that maximizes the objective function. The constraint extraction can then determine which of the selected Lagrange multipliers λ and corresponding product prices satisfies a business objective. In such an embodiment the business objective can incorporate a variety of business strategies and rules. A detailed example of such an optimization technique will be discussed with reference to FIG. 7. It should be noted however, the other techniques for optimizing the objective function can be used. Other examples of techniques that could be used include simulated annealing, genetic algorithms, sample search, and multiply-seeded gradient descent.

With the objective function optimized, the next step 608 is to generate and persist price recommendations for each of the products using the optimized objective function. Again, because of the non-convexity in the objective function, specific techniques for determining the prices are used in step 608. In one embodiment, the prices for each product are determined by finding a local extrema in the derivative of the optimized objective function with respect to price for each of the set of products. This can be performed by setting derivative of the objective function with respect to item price is set to zero and solving for price. For example, by solving:

$$\frac{\partial ( P + λ R )}{\partial {Price}_{i}} = 0. \qquad Equation 11$$

for each item in the set of products.

With the improved prices determined, the next step 610 is to perform an iterative simulation to identify constraints that can be used to approximate optimization based on competitive components. The iterative simulation of step 610 is performed to determine what type of constraints, when applied to the price optimization that uses a limited demand model (e.g., limited demand model 122 of FIG. 1), would result in optimized prices that would closely approximate the prices that would have been obtained with an optimization using a demand model with competitive components (e.g., demand model 118). Specifically, the constraints can be generated by performing an iterative simulation using the improved prices and the limited demand model to determine what type of constraints, when applied to an optimization using the limited demand model, will result in an optimization that approximates the corresponding optimization using the full demand model and a full complement of up to date competitive history data. Stated another way, the improved prices generated using the full demand model serve as a target for the iterative simulation using the limited demand model, such that the constraints generated during the iterative simulation will result in an optimization that approximates price optimization using the competitive components. Thus, with the constraints generated using competitive history data, the limited demand model can be used with constraints during later optimizations to provide an improved price optimization for circumstances where competitive history data is not fully available.

With the constraints identified, the next step 612 is to persist the constraints in a manner such that they can be used for future price optimizations.

Turning now to FIG. 7, an objective function optimizing method 700 is illustrated. Specifically, the method 700 is implemented to optimize an objective function with significant non-convexity, and thus can optimize an objective function with a demand model that incorporates competitive price history. As such, the method 700 is one example of a technique that can be used in step 606 of method 600, and thus is an example of a technique that can be used in constraint extraction.

The first step 702 in method 700 is to produce a consensus forecast function for each product in the set of products. It should be noted that each product has its own demand parameters, including average velocity (a reflection of relative popularity of an item), own price elasticity, sensitivity to competitor price, and promotional response characteristics. Each consensus forecast function provides a predictive forecast for each item's demand as a function of the noted factors of price, promotion, and relative competitor price.

In general, the consensus forecast functions can be generated by applying random perturbations to the objective function for each product, measuring the results, and using measured relationship between the random inputs and the corresponding results to generate consensus demand forecasts for each product.

In one example, a consensus forecast function can be produced using a Monte Carlo method of applying random inputs to an objective function. In general, consensus forecast functions generated using Monte Carlo methods can provide the ability to solve complex systems, including those that are non-linear, non-convex, and have multi-dimensional uncertainty. Stated another way, consensus forecast functions generated using Monte Carlo methods can provide accurate understandings of non-convex objective functions that have multiple dimensions of uncertainty.

In one more specific example, the consensus forecast function can be produced using a type of Monte Carlo method where the randomized perturbations applied to the input as part of Monte Carlo simulation are generated according to the joint parametric uncertainty between own price elasticity and competitor price sensitivity. The joint parametric uncertainty can be measured as an artifact of the estimation process. In one specific embodiment, this relationship can be derived from a Fisher matrix (i.e., the second derivative of the Bayesian likelihood function). In this embodiment, the submatrix of the inverse Fisher matrix corresponding to the parameters of own price elasticity and competitor price sensitivity provides a covariance estimate between these parameters.

In this case, the Monte Carlo analysis involves exposing the objective function to randomized perturbations in these demand parameters generated from a zero-mean, multivariate distribution with covariance dictated by the mechanism described above. In this way, the Monte Carlo analysis generates an ensemble of forecast models that vary in a manner consistent with the knowledge of parametric uncertainty (as derived in the coefficient estimation). Because the demand model in these embodiments is non-linear and has greater dependency on variation in these parameters for some regions of the pricing curve than others, Monte Carlo analysis can provide a robust means of estimating a consensus forecast for every price point. Such a consensus forecast can provide an improved basis for price optimization.

Turning briefly to FIG. 8 a graph 800 illustrates exemplary results from applying random perturbations to the objective function. Specifically, graph 800 shows an exemplary mapping of the different objective function results (each represented by a different curve) generated by applying random inputs to an objective function. For example, by applying different values of price elasticity and/or competitor price switching sensitivity. Again, such a mapping can be used in a Monte Carlo method to generate a consensus forecast function.

Returning to FIG. 7, when so generated, the consensus forecast function can provide estimations of demand versus price for the objective function, and these estimations of demand can be used to optimize the objective function and find optimal product prices that satisfy business objectives.

The next step 704 in method 700 is to select Lagrange multipliers for testing in the optimization of the objective function. Again, in the examples of Equations 7 and 8 above, the value of is a Lagrange multiplier for the respective objective function. A variety of techniques can be used to select the Lagrange multipliers for testing. For example, a starting value and sweeping range of Lagrange multiplier can be selected. In one specific embodiment, a value for the Lagrange multiplier obtained in a previous optimization is used as a starting value, and additional values are selected by performing a bisectional search over the range of possible values during optimization of the objective function.

The next step 706 in method 700 is to, for each selected value of the Lagrange multiplier, find product prices using the consensus forecast function that maximizes the value of the objective function. In general, this step involves selecting a value of the Lagrange multiplier and using the consensus forecast function to find the product prices that maximize the objective function. When the product prices that maximize the object function are determined, this effectively results in an optimized objective function for every selected value of the Lagrange multiplier.

The process of determining the product prices that maximize the value of the object function for each Lagrange multiplier value can be performed in a variety of ways. For example, this optimization can be accomplished using a coarse sample search with bisection, as the objective space is likely to be locally convex in the vicinity of its multiple maxima. Other techniques that can be used include multi-seeded hill climbing (gradient descent). Such approaches are likely to find the global optimum provided that there sufficient samples to guarantee that at least one of the starting points lies within the locally-convex region of the global optimum price for each product.

Additionally, an “outer” iteration loop can be used to incrementally adjust for substitution cross-effects, which can be computed at each step. In general, this outer iteration loop would include the steps of 1) calculating substitution influence for competing products based on starting (current) price points for all products in the set; 2) while holding cross-effects constant, performing a multiply-seeded bisection or gradient descent search to identify the global optimum price for each product in the set; 3) re-computing substation cross effects based on the new prices identified in (2); and repeating steps 2) and 3) until the observed price variation between iterations for all products in the set is less than a specified tolerance level.

Thus, step 706 of method 700 results in a plurality of Lagrange multiplier values and associated product prices. It should be noted that in this context every value of Lagrange multiplier results in an objective function that is Pareto optimal, but only those values that also meet business objectives result in optimal prices. Stated another way, for each value of the Lagrange multiplier there is a unique pricing solution that is Pareto optimal, where pricing solutions are Pareto optimal when they lie on the opportunity curve. The opportunity curve reflects the set of all possible solutions for which the highest attainable profit is realized for a given value of sales revenue within a category of products (or vice versa). Thus, the opportunity curve represents a narrow subset of all possible pricing solutions, and in setting optimized prices, only solutions that lie on that opportunity curve are optimal and should be considered.

While every choice of Lagrange multiplier thus yields a Pareto-optimal pricing solution, there is a unique value of the Lagrange multiplier that also satisfies a defined business objective specified by the retailer. Thus, the next step 708 in method 700 is to find the Lagrange multiplier value that also satisfies a defined business objective. In general, this step involves selecting a business objective regarding pricing and evaluating the Lagrange multipliers and product prices determined in step 706 to ensure that the prices selected meet that business objective.

A variety of business objectives with regard to product pricing can be used in step 708. For example, one possible business objective can be to maximize profit while maintaining gross margin rate associated with current product prices. Another exemplary business objective is to maximize profit while sacrificing no more than 3% of revenue at current prices. Another exemplary business objective is to maximize incremental revenue gain while maintaining current profit dollars. Finally, another exemplary business objective is to maximize profit without sacrificing total unit sales volume.

In each of these examples the business objectives is defined, and the step 708 finds the Lagrange multiplier value and corresponding prices that also satisfies the business objective. This step can be performed by searching over a range of values for the Lagrange multiplier. Again, each value for the Lagrange multiplier yields a set of prices and associated profit and revenue performance, but there is a single value of the Lagrange multiplier Lambda that meets the overarching business objective.

With the Lagrange multiplier that satisfies the business objective determined, the prices resulting from that Lagrange multiplier value can be determined. As was described with reference to FIG. 6, this is done by finding a local extrema in the derivative of the optimized objective function with respect to price for each of the set of products. For example, by finding a local maximum of the derivative of the objective function with respect to item prices. This local maximum represents a stationary point at which the gradient of the objective function with respect to all product prices is zero. As has been noted, the functional form used to describe competitor pricing influence on product demand gives rise to a non-convex objective function with multiple extrema, so the zero-gradient condition is necessary but not sufficient to indicate a global optimum of the objective function.

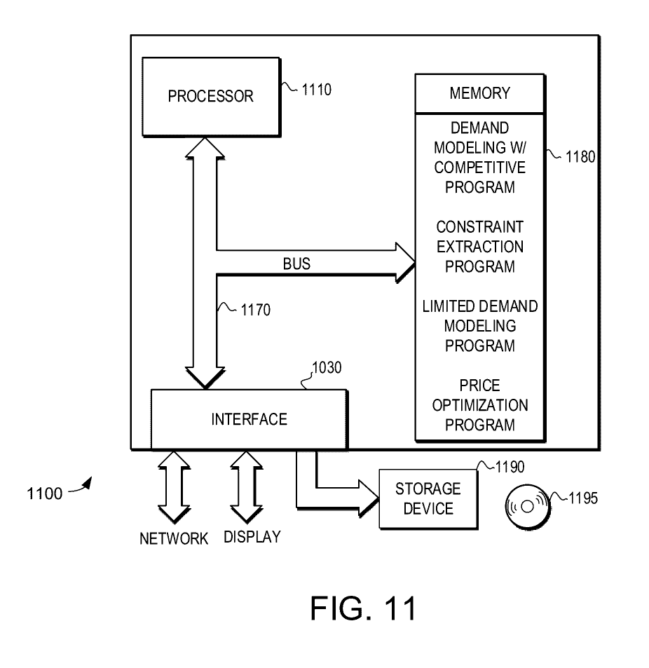

Turning now to FIG. 9 graphs 900, 910 and 920 illustrates exemplary optimized objective functions for different values of the Lagrange multiplier λ. Specifically, graph 900 shows an exemplary optimized objective function for λ=0.25, graph 910 shows an exemplary optimized objective function for λ=1, graph 920 shows an exemplary optimized objective function for a λ=2. As can be seen in these three graphs, the different values of λ change the shape of the optimized objective function. The changing shape of the optimized objective function illustrates that a shift in business objectives can cause the optimum price to shift considerably from one local optimum to another. This is another way of saying that the sharply-transient demand response due to competitive influence amplifies the choice of strategy in terms of impact to optimized prices relative to a simpler model that treats only price elasticity in the absence of competitive cross-effects.

Returning briefly to FIG. 1, as was described above, the demand modeling module 102 and the constraint extraction module 104 use competitive history data to generate constraints that are used to generate improved pricing recommendations. Specifically, those generated constraints can be used to provide those improved pricing recommendations even when competitive history data is limited. Specifically, by using available competitive history data to generate constraints, and then using the constraints for additional price optimizations for situations where sufficient competitive history data for a full optimization would is unavailable.

To accomplish this, the extracted constraints are passed to the price optimization module 110. Then during operation, the limited demand modeling module 108 would generate limited demand model 122 without the use competitive history data, and the price optimization module 110 would use the limited demand model 122 and the extracted constraints to generate pricing recommendations.

The techniques used by the limited demand modeling module 108 to generate the limited demand model 122 would generally parallel those used by the demand modeling module 102 (e.g., method 400), with the differences being that terms for competitive history would not be included in the demand model. Other estimation approaches could include simple least squares, regularized regression, maximum likelihood estimation, or use of non-parametric models.

The product data 120 used by the limited demand modeling module 108 would generally include the same types of data as was included in product data 116. For example, the product data can include information such as product cost, product categories and hierarchies, and the seller's demand history of the product, including the quantity sold versus price for the set of products for the seller. Likewise, the demand model using the demand modeling module 108 can again be represented as was described above with reference to Equation 2, where D(t) represents the time varying demand signature, X(t) represents the time varying substitution pressure for competing products and is a function of computing utility of substitutable product options, and uᵢ represents the utility of the item. In this case however, the utility term uᵢ would not include the additional terms representing competitive price history on product demand.

Turning now to FIG. 10, a price optimization method 1000 is illustrated. The price optimization method 1000 is an example of the type method that could be performed by a price optimization module (e.g., price optimization module 110 of FIG. 1). In general, the method 1000 uses a limited demand model (e.g., limited demand model 122) and extracted constraints to generate pricing recommendations.

The first step 1002 in method 1000 is to receive data, the demand model with estimated coefficients, and the extracted constraints. This data will again include product data such as seller's price and demand history, and the demand model will include terms representing time varying demand, substitution, utility and the corresponding generated constraints.

The next step 1004 is to define an objective function. Again, the objective function defined in step 1004 provides a representation of a business objective that is to maximized or otherwise optimized, and is typically combination of profit and revenue metrics. Again, examples of objective functions were described above with reference to Equations 7-10.

The next step 1006 is to optimize the objective function using the demand model and subject to the extracted constraints. In general, this optimization of the demand model finds the best possible outcome using the demand model coefficients to determine the quantities of items that will be sold at given prices. Additionally, this optimization is performed to find these prices subject to a defined business objective.

A variety of business objectives with regard to product pricing can be used in step 1006. For example, one possible business objective can be to maximize profit while maintaining gross margin rate. Another exemplary business objective is to maximize profit while sacrificing no more than 3% of revenue at current prices. Another exemplary business objective is to maximize incremental revenue gain while maintaining current profit dollars. Finally, another exemplary business objective is to maximize profit without sacrificing total unit sales volume. In each case, the business objectives are used to the optimized prices.

In accordance with the embodiments described herein, this optimization of the objective function is done subjected to the constraints extracted using competitive history data. Because the constraints were extracted using competitive history data, they can be used to provide those improved pricing recommendations even when up to date competitive history data for a full optimization is unavailable. As was noted above, the objective function used in this step can be strictly convex given the lack of demand model terms representing the effects of competitive price history on product demand.

For this reason, a wide variety of different techniques can be used to optimize the objective function. For example, the objective function can be optimized using techniques such as gradient descent, sample search, or bisection search.

A variety of techniques can also be used to perform this optimization subject to subject to the extracted optimization constraints. Specifically, the extracted constraints can be used by a variety of approaches including nonlinear programming, sequential quadratic programming, iterative linear approximation with linear programming (LP) or mixed-integer programming (MIP) solvers, simulated annealing, or genetic algorithms.

With the objective function optimized, the next step 1008 is to generate and persist price recommendations for each of the products using the optimized objective function. In one embodiment, the prices for each product are determined by finding a local extrema in the derivative of the optimized objective function with respect to price for each of the set of products. This can be performed by setting derivative of the objective function with respect to item price is set to zero and solving for price.

With the final optimized prices determined, those prices can then be provided to the retailer pricing system (e.g., retailer pricing system 112). There, the retailer pricing system can utilize these prices to set prices for the retail store. Typically, the implementation of this step with the retailer pricing system will vary based on the type of retailer. For example, online and brick-and-mortar retailers typically have different pricing systems given the relative complexity to change retail prices in a store compared to an online retailer. Additionally, in some cases other factors will be used in determining how to roll out optimized prices to various retailers.

The demand modeling module 102, the constraint extraction module 104, limited demand model module 108 and price optimization module 110, and the various methods described above can be can be implemented on a wide variety of platforms. In general, the term “module” as defined herein identifies a combination of processing hardware and software configured to be executed during price optimization. As such, each module will include executable code that is typically part of a larger application that is loaded into memory and executed by one or more processors in a processing system. When so executed, each module will perform its associated actions, such as methods illustrated in FIGS. 4-7 and 10. Turning now to FIG. 11, an exemplary processing system 1100 is illustrated. Processing system 1100 illustrates the general features of a processing system that can be used to implement the invention. Of course, these features are merely exemplary, and it should be understood that the invention can be implemented using different types of hardware that can include more or different features. It should be noted that the processing system 1100 can be implemented in many different environments, such as part of large networked computer system that spans multiple sites or as discrete individual computer system. The exemplary processing system 1100 includes a processor 1110, an interface 1130, a storage device 1190, a bus 1170 and a memory 1180. In accordance with the embodiments of the invention, the memory 1180 includes at least a demand modeling program, constraint extraction program, limited demand modeling program, and price optimization program.

The processor 1110 performs the computation and control functions of the system 1100. The processor 1110 may comprise any type of processor, include single integrated circuits such as a microprocessor, or may comprise any suitable number of integrated circuit devices and/or circuit boards working in cooperation to accomplish the functions of a processing unit. In addition, processor 1110 may comprise multiple processors implemented on separate systems. In addition, the processor 1110 may be part of an overall larger computer system. During operation, the processor 1110 executes the programs contained within memory 1180 and as such, controls the general operation of the processing system 1100.

Memory 1180 can be any type of suitable memory. This would include the various types of dynamic random access memory (DRAM) such as SDRAM, the various types of static RAM (SRAM), and the various types of non-volatile memory (PROM, EPROM, and flash). It should be understood that memory 1180 may be a single type of memory component, or it may be composed of many different types of memory components. In addition, the memory 1180 and the processor 1110 may be distributed across several different physical devices that collectively processing system 1100. For example, a portion of memory 1180 may reside on one computer system, and another portion may reside on a second computer system.

The bus 1170 serves to transmit programs, data, status and other information or signals between the various components of processing system 1100. The bus 1170 can be any suitable physical or logical means of connecting computer systems and components. This includes, but is not limited to, direct hard-wired connections, fiber optics, infrared and wireless bus technologies. It should also be noted that the processing system 1100 could be implemented as a single system on a chip (SoC). In such a case the bus 1170 can comprise the internal bus of the SoC.

The interface 1130 allows communication to the processing system 1100, and can be implemented using any suitable method and apparatus. It can include a network interfaces to communicate to other systems such as an inventory system (e.g., retailer pricing system 112) and, terminal interfaces to communicate with technicians, and storage interfaces to connect to storage apparatuses such as storage device 1190. Storage device 1190 can be any suitable type of storage apparatus, including direct access storage devices such as hard disk drives, flash systems, floppy disk drives and optical disk drives. As shown in FIG. 11, storage device 1190 can comprise a disc drive device that uses discs 1195 to store data.

In accordance with the embodiments described herein, the processing system 1100 implements a demand modeling module and a price optimization module. Thus during operation, these elements and others can be implemented by storing associated program modules in the memory 1180 to be executed by processor 1110.

It should be understood that while the present invention is described here in the context of a fully functioning computer system, those skilled in the art will recognize that the mechanisms of the present invention are capable of being distributed as a program product in a variety of forms, and that the embodiments described herein apply equally regardless of the particular type of recordable media used to carry out the distribution. Examples of recordable media include: magnetic disks, flash memory devices, hard drives, memory cards and optical disks (e.g., disc 1195).

The foregoing description of specific embodiments reveals the general nature of the inventive subject matter sufficiently that others can, by applying current knowledge, readily modify and/or adapt it for various applications without departing from the general concept. Therefore, such adaptations and modifications are within the meaning and range of equivalents of the disclosed embodiments. The inventive subject matter embraces all such alternatives, modifications, equivalents, and variations as fall within the spirit and broad scope of the appended claims.

The forgoing detailed description is merely illustrative in nature and is not intended to limit the embodiments of the subject matter or the application and uses of such embodiments. As used herein, the word “exemplary” means “serving as an example, instance, or illustration.” Any implementation described herein as exemplary is not necessarily to be construed as preferred or advantageous over other implementations. Furthermore, there is no intention to be bound by any expressed or implied theory presented in the preceding technical field, background, brief summary or the following detailed description.

Techniques and technologies may be described herein in terms of functional and/or logical block components and with reference to symbolic representations of operations, processing tasks, and functions that may be performed by various computing components or devices. Such operations, tasks, and functions are sometimes referred to as being computer-executed, computerized, software-implemented, or computer-implemented. In practice, one or more processor devices can carry out the described operations, tasks, and functions by manipulating electrical signals representing data bits at memory locations in the system memory, as well as other processing of signals. The memory locations where data bits are maintained are physical locations that have particular electrical, magnetic, optical, or organic properties corresponding to the data bits. It should be appreciated that the various block components shown in the figures may be realized by any number of hardware, software, and/or firmware components configured to perform the specified functions. For example, an embodiment of a system or a component may employ various integrated circuit components, e.g., memory elements, digital signal processing elements, logic elements, look-up tables, or the like, which may carry out a variety of functions under the control of one or more microprocessors or other control devices.

For the sake of brevity, conventional techniques related to price optimization, and other aspects of certain systems and subsystems (and the individual operating components thereof) may not be described in detail herein. Furthermore, the connecting lines shown in the various figures contained herein are intended to represent exemplary functional relationships and/or physical couplings between the various elements. It should be noted that many alternative or additional functional relationships or physical connections may be present in an embodiment of the subject matter.

What is claimed is:

1. A price optimization method comprising:
performing a first modeling of demand for a set of products based at least in part on competitive history data for the set of products product, where the competitive history data includes a time series of competitors' prices for the set of products for at least a first competitor; and
generating optimization constraints based the first modeling of demand;
performing a second modeling of demand of the set of products based at least in part on product data for the set of products; and
generating optimized prices for the set of products based on the second modeling of demand and using the optimization constraints from the first modeling of demand.

2. The method of claim 1, wherein the step of performing the first modeling of demand is further based at least in part on seller data, where the seller data includes a time series of quantity sold versus price for the set of products for a first seller.

3. The method of claim 1, wherein the step of performing the first modeling of demand comprises providing a first plurality of demand models, with each demand model in the first plurality of demand models corresponding to a product in a set of products, and each demand model in the first plurality of demand models including a term representing an effect of competitive price history on product demand for the corresponding product in the set of products.

4. The method of claim 3, wherein the step of performing the first modeling of demand additionally comprises generating coefficients for the first plurality of demand models using the competitive history data.

5. The method of claim 4, wherein the step of generating coefficients for the first plurality of demand models comprises performing empirical Bayesian estimation.

6. The method of claim 1, wherein the step of generating optimization constraints comprises:
optimizing a first objective function, the first objective function defining a business objective in terms of profit and revenue relating to the set of products;
generating an improved price for each of the set of the products using the optimized first objective function; and
performing an iterative simulation of a second objective function to identify the optimization constraints that result in prices approximating the improved price for each of the set of the products.

7. The method of claim 6, wherein the step of optimizing the first objective function comprises:
determining a Lagrange multiplier value that satisfies a business objective using a consensus forecast function.

8. The method of claim 7, wherein the consensus forecast function is produced with a Monte Carlo method.

9. The method of claim 7, wherein the step of determining the Lagrange multiplier value that satisfies a business objective using the consensus forecast function comprises:
selecting a set of Lagrange multipliers;
for each selected Lagrange multiplier, finding a product price using the consensus forecast function that maximizes the objective function; and
determining which of the selected Lagrange multiplier and corresponding product price satisfies the business objective using the product price.

10. The method of claim 1, wherein the step of generating optimized prices for the set of products based on the second modeling of demand and using the optimization constraints from the first modeling of demand comprises:
using iterative linear approximation with the optimization constraints.

11. The method of claim 1, wherein the competitive history data includes a time series of competitors' prices for the set of products for each of multiple competitors, and wherein the step of generating optimization constraints comprises weighting the optimization constraints based at least impart on relative influence on demand for each of the multiple competitors.

12. The method of claim 11, wherein the weighting of the optimization constraints is based at least in part on relative influence on demand for each of the multiple competitors is based upon predetermination of their relative influence upon product demand.

13. A price optimization method comprising:
providing a plurality of demand models, with each demand model corresponding to a product in a set of products, and each demand model including a term representing an effect of competitive price history on product demand for the corresponding product in the set of products;
generating coefficients for each of the plurality of demand models using Bayesian priors and empirical Bayesian estimation with shrinkage techniques using seller data and competitive history data, where the seller data includes a time series of quantity sold versus price for each product in the set of products for a first seller, and where the competitive history data includes a time series of competitors price for each product in the set of products for at least one competitor;
providing an objective function, the objective function defining a business objective in terms of profit and revenue relating to the set of products, the objective function incorporating the plurality of demand models and generated coefficients for the plurality of demand models, and wherein the objective function includes significant non-convexity as a result of the demand model terms representing the effects of competitive price history on product demand;
optimizing the objective function to find a Lagrange multiplier value that satisfy a business objective using a consensus forecast function produced with a Monte Carlo method;
generating optimization constraints based the optimized objective function;
performing a second modeling of demand of the set of products based at least in part on product data for the set of products; and
generating optimized prices for the set of products that meet a business objective based on the second modeling of demand and using the optimization constraints from the first modeling of demand.

14. The method of claim 13, wherein the step of generating optimization constraints comprises:
generating an improved price for each of the set of the products using the optimized objective function; and
performing an iterative simulation of a second objective function to identify the optimization constraints that result in prices approximating the improved price for each of the set of the products.

15. An apparatus comprising:
a processor;
a memory coupled to the processor; and
a program residing in the memory and being executed by the processor, the program including:
a demand modeling module, the demand modeling module configured to perform a first modelling of demand for a set of products based at least in part on competitive history data for the set of products, where the competitive history data includes a time series of competitors' prices for the set of products for at least a first competitor; and
a constraint extraction module, the constraint extraction module configured to generate optimization constraints based the first modeling of demand;
a limited demand modeling module, the limited demand modeling module configured to perform a second modeling of demand of the set of products based at least in part on product data for the set of products; and
a price optimization module, the price optimization module configured to generate optimized prices for the set of products based on the second modeling of demand and using the optimization constraints from the first modeling of demand.

16. The apparatus of claim 15, wherein the demand modeling module is configured to perform the first modeling of demand further based at least in part on seller data, where the seller data includes a time series of quantity sold versus price for the set of products for a first seller.

17. The apparatus of claim 15, wherein the demand modeling module is configured to perform the first modeling of demand by providing a first plurality of demand models, with each demand model in the first plurality of demand models corresponding to a product in a set of products, and each demand model in the first plurality of demand models including a term representing an effect of competitive price history on product demand for the corresponding product in the set of products.

18. The apparatus of claim 17, wherein the demand modeling module is further configured to perform the first modeling of demand by generating coefficients for the first plurality of demand models using the competitive history data.

19. The apparatus of claim 18, wherein the demand modeling module is configured to generate coefficients for the first plurality of demand models by performing empirical Bayesian estimation.

20. The apparatus of claim 15, wherein the constraint extraction module is configured to generate optimization constraints by:
optimizing a first objective function, the first objective function defining a business objective in terms of profit and revenue relating to the set of products;
generating an improved price for each of the set of the products using the optimized first objective function; and
performing an iterative simulation of a second objective function to identify the optimization constraints that result in prices approximating the improved price for each of the set of the products.

21. The apparatus of claim 20, wherein constraint extraction module is configured to optimize the first objective function by determining a Lagrange multiplier value that satisfies a business objective using a consensus forecast function.

22. The apparatus of claim 21, wherein constraint extraction module is configured to generate the consensus forecast function using a Monte Carlo method.

23. The apparatus of claim 21, wherein constraint extraction module is configured to determine the Lagrange multiplier value that satisfies a business objective using the consensus forecast function by:
selecting a set of Lagrange multipliers;
for each selected Lagrange multiplier, finding a product price using the consensus forecast function that maximizes the objective function; and
determining which of the selected Lagrange multiplier and corresponding product price satisfies the business objective using the product price.

24. The apparatus of claim 15, wherein the price optimization module is configured to generate optimized prices for the set of products based on the second modeling of demand and using the optimization constraints from the first modeling of demand by:
using iterative linear approximation with the optimization constraints.

25. The apparatus of claim 15, wherein the competitive history data includes a time series of competitors' prices for the set of products for each of multiple competitors, and wherein the a constraint extraction module is configured to generate optimization constraints based the first modeling of demand step of generating optimization by weighting the optimization constraints based at least impart on relative influence on demand for each of the multiple competitors.

26. The apparatus of claim 25, wherein the constraint extraction module is configured to weight the optimization constraints based at least in part on relative influence on demand for each of the multiple competitors is based upon predetermination of their relative influence upon product demand.

27. An apparatus comprising:
a processor;
a memory coupled to the processor; and
a program residing in the memory and being executed by the processor, the program configured to perform the steps of:
providing a plurality of demand models, with each demand model corresponding to a product in a set of products, and each demand model including a term representing an effect of competitive price history on product demand for the corresponding product in the set of products;
generating coefficients for each of the plurality of demand models using Bayesian priors and empirical Bayesian estimation with shrinkage techniques using seller data and competitive history data, where the seller data includes a time series of quantity sold versus price for each product in the set of products for a first seller, and where the competitive history data includes a time series of competitors price for each product in the set of products for at least one competitor;
providing an objective function, the objective function defining a business objective in terms of profit and revenue relating to the set of products, the objective function incorporating the plurality of demand models and generated coefficients for the plurality of demand models, and wherein the objective function includes significant non-convexity as a result of the demand model terms representing the effects of competitive price history on product demand;
optimizing the objective function to find a Lagrange multiplier value that satisfy a business objective using a consensus forecast function produced with a Monte Carlo method;
generating optimization constraints based the optimized objective function;
performing a second modeling of demand of the set of products based at least in part on product data for the set of products; and
generating optimized prices for the set of products that meet a business objective based on the second modeling of demand and using the optimization constraints from the first modeling of demand.

28. The apparatus of claim 27, wherein the program is configured to perform the step of generating optimization constraints by:
generating an improved price for each of the set of the products using the optimized objective function; and
performing an iterative simulation of a second objective function to identify the optimization constraints that result in prices approximating the improved price for each of the set of the products.
